(19) United States
(12) Patent Application Publication
(10) Pub. No.: US 2013/0163582 A1
(43) Pub. Date: Jun. 27, 2013

(54) SYSTEMS AND METHODS OF MANAGING COMMUNICATION REQUESTS IN A VOIP COMMUNICATION SYSTEM

(71) Applicants: Jaya MEGHANI, Old Bridge, NJ (US); Kevin Huang, West Windsor, NJ (US); Kai Xin, East Brunswick, NJ (US)

(72) Inventors: Jaya MEGHANI, Old Bridge, NJ (US); Kevin Huang, West Windsor, NJ (US); Kai Xin, East Brunswick, NJ (US)

(21) Appl. No.: 13/337,208

(22) Filed: Dec. 26, 2011

(51) Int. Cl. H04L 12/66

(52) U.S. Cl. 370/352

(57) ABSTRACT

An Internet protocol (IP) telephony system includes elements that prevent more than a specified number of simultaneous calls to be carried by the IP telephony system under a single user account. Multiple copies of a call session database are maintained in different geographical areas, and the multiple copies of the call session database are frequently and rapidly synchronized. The call session database is consulted before a new call is setup to determine if the user account that is to be used for the new call already is being used for a maximum number of simultaneous calls. If so, the new call setup request is denied.

### BACKGROUND OF THE INVENTION

The invention is related to Internet protocol (IP) telephony systems that allow users to place and receive telephone calls, and to send and receive text and video messages via data packets that are communicated over a data network.

Users of an IP telephony system typically enter into a monthly service contract with the IP telephony system. The monthly service contract typically allows the user to place an unlimited number of telephone calls to telephone numbers located within a defined service area. If the user wishes to place a call to a telephone number located outside of the defined service area, additional per minute charges usually apply.

When the IP telephony system prices such unlimited calling plans, the IP telephony system makes some assumptions about the number of calls that the user is likely to place and/or receive in any given month. Although the actual number of calls will vary from user to user, the IP telephony system prices the plan so that it can operate at a profit based on the total volume of all calls for all users under all similar plans.

Unlike with traditional PSTN based telephony service plans, an IP telephony service plan allows a user to place and receive calls from any location at which an Internet or data network connection is available. Also, a user can often configure multiple different IP telephony devices for use under a single user account.

When an IP telephony system prices the monthly service charges for a user account, the IP telephony system assumes that only a limited number of people will have access to the IP telephony devices that are configured to use that account. Unfortunately, there is a potential for fraudulent and/or excessive use of the IP telephony service by configuring multiple different IP telephony devices to send and receive calls under the same user account, and for those IP telephony devices to be used by many different people in multiple different geographical locations. If this occurs, the IP telephony system will be forced to carry much more traffic than originally anticipated, which would reduce or eliminate the profit of providing service.

To prevent this type of abuse, it is necessary to manage and, in some cases, prevent multiple simultaneous calls from being carried through the IP telephony system under the same account. This is difficult, however, because an IP telephony system allows its users to place and receive telephone calls from an IP telephony device virtually anywhere in the world. While it might be easy to check for simultaneous calls within a relatively small geographical region, doing so worldwide is problematic.

### BRIEF DESCRIPTION OF THE DRAWINGS

FIG. 1 is a diagram of a communications environment including various elements which are associated with an Internet protocol (IP) telephony system embodying the invention;

FIG. 2 is a diagram of various elements of a processor that forms part of an IP telephony system;

FIG. 3 is a block diagram illustrating a communications environment that includes an IP telephony system embodying the invention; and

FIG. 4 illustrates elements of a simultaneous call management unit embodying the invention.

### DETAILED DESCRIPTION OF PREFERRED EMBODIMENTS

The following detailed description of preferred embodiments refers to the accompanying drawings, which illustrate specific embodiments of the invention. Other embodiments having different structures and operations do not depart from the scope of the present invention.

In the following description, the terms VOIP system, VOIP telephony system, IP system and IP telephony system are all intended to refer to a system that connects callers and that delivers data, text and video communications using Internet protocol data communications.

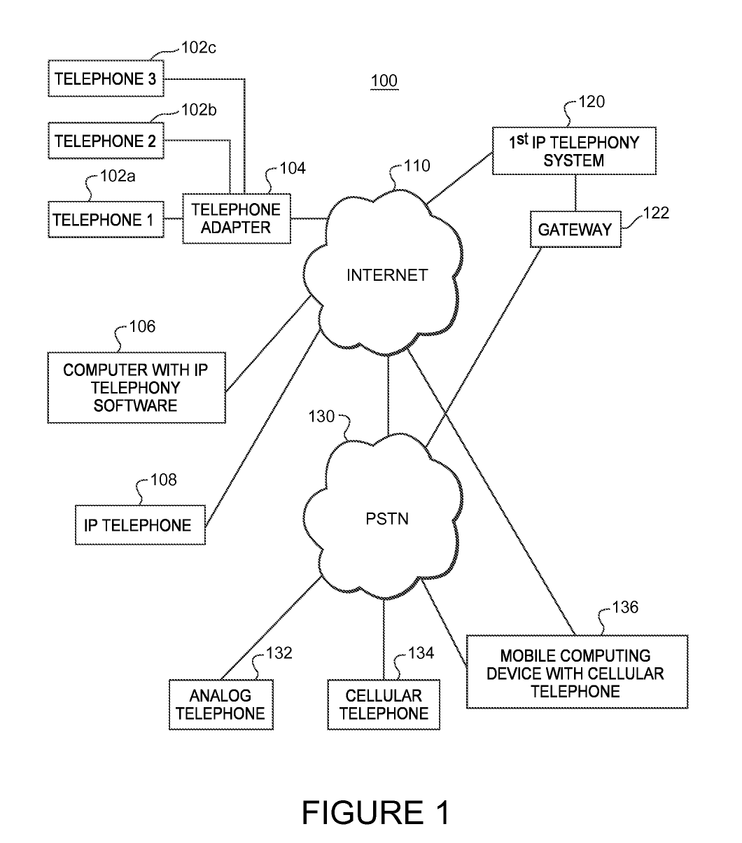

As illustrated in FIG. 1, a communications environment 100 is provided to facilitate IP enhanced communications. An IP telephony system 120 enables connection of telephone calls between its own customers and other parties via data communications that pass over a data network 110. The data network 110 is commonly the Internet, although the IP telephony system may also make use of private data networks. The IP telephony system 120 is connected to the Internet 110. In addition, the IP telephony system 120 is connected to a publicly switched telephone network (PSTN) 130 via a gateway 122. The PSTN 130 may also be directly coupled to the Internet 110 through one of its own internal gateways (not shown). Thus, communications may pass back and forth between the IP telephony system 120 and the PSTN 130 through the Internet 110 via a gateway maintained within the PSTN 130.

The gateway 122 allows users and devices that are connected to the PSTN 130 to connect with users and devices that are reachable through the IP telephony system 120, and vice versa. In some instances, the gateway 122 would be a part of the IP telephony system 120. In other instances, the gateway 122 could be maintained by a third party.

Customers of the IP telephony system 120 can place and receive telephone calls using an IP telephone 108 that is connected to the Internet 110. Such an IP telephone 108 could be connected to an Internet service provider via a wired connection or via a wireless router. In some instances, the IP telephone 108 could utilize the data channel of a cellular telephone system to access the Internet 110.

Alternatively, a customer could utilize a analog telephone 102a which is connected to the Internet 110 via a telephone adapter 104. The telephone adapter 104 converts analog signals from the telephone 102a into data signals that pass over the Internet 110, and vice versa. Also, as illustrated in FIG. 1, multiple analog telephone devices 102a, 102b and 102c could all be coupled to the same telephone adaptor 104. Analog telephone devices include but are not limited to standard telephones and document imaging devices such as facsimile machines. A configuration using a telephone adapter 104 is common where all of the analog telephone devices 102a, 102b and 102c are located in a residence or business, and all of the telephone devices are connected to the same telephone adapter. With this type of a configuration, all of the analog telephone devices 102a, 102b, 102c share the same telephone number assigned to the telephone adapter 104. Other configurations are also possible where multiple communication lines (e.g., a second telephone number) are provisioned by the IP telephony system 120.

In addition, a customer could utilize a soft-phone client running on a computer 106 to place and receive IP based telephone calls, and to access other IP telephony systems (not shown). In some instances, the soft-phone client could be assigned its own telephone number. In other instances, the soft-phone client could be associated with a telephone number that is also assigned to an IP telephone 108, or to a telephone adapter 104 that is connected one or more analog telephones 102.

A third party using an analog telephone 132 which is connected to the PSTN 130 may call a customer of the IP telephony system 120. In this instance, the call is initially connected from the analog telephone 132 to the PSTN 130, and then from the PSTN 130, through the gateway 122 to the IP telephony system 120. The IP telephony system 120 would then route the call to the customer's IP telephony device. A third party using a cellular telephone 134 could also place a call to an IP telephony system customer, and the connection would be established in a similar manner, although the first link would involve communications between the cellular telephone 134 and a cellular telephone network. For purposes of this explanation, the cellular telephone network is considered part of the PSTN 130.

In addition, mobile computing devices which include cellular telephone capabilities could also be used to place telephone calls to customers of the IP telephony system. A mobile computing device 136, as illustrated in FIG. 1, might connect to the PSTN 130 using its cellular telephone capabilities. However, such devices might also have the ability to connect to a data network, such as the Internet 110 wirelessly via some other means. For instance, a mobile computing device 136 might communicate with a wireless data router to connect the mobile computing device 136 directly to a data network, such as the Internet 110. In this instance, communications between the mobile computing device 136 and other parties could be entirely carried by data communications which pass from the mobile computing device 136 directly to a data network 110. Of course, alternate embodiments could utilize any other form of wireless communications path to enable communications.

Users of the IP telephony system 120 are able to access the service from virtually any location where they can connect to the Internet 110. Thus, a customer could register with an IP telephony system provider in the U.S., and that customer could then use an IP telephone 108 located in a country outside the U.S. to access the services. Likewise, the customer could also utilize a computer outside the U.S. that is running a soft-phone client to access the IP telephony system 120.

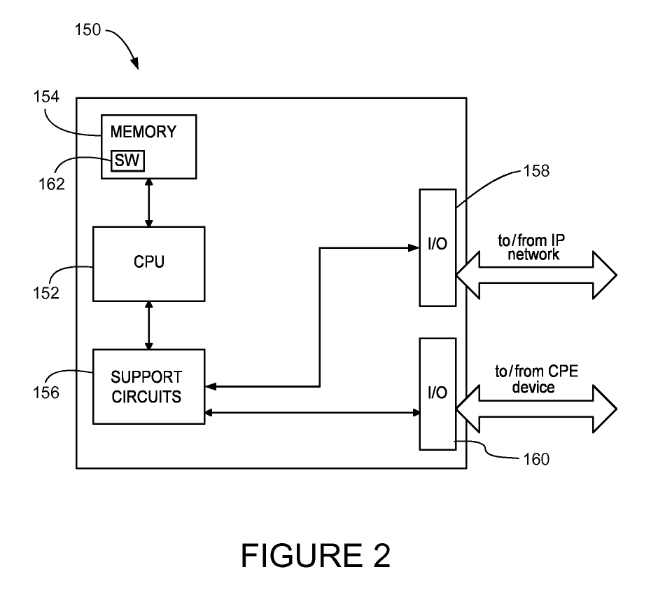

FIG. 2 illustrates elements of a computer processor 150 that can be used as part of the IP telephony system 120 to accomplish various functions. The IP telephony system 120 could include multiple processors 150 located at various locations in the system, along with their operating components and programming, each carrying out a specific or dedicated portion of the functions performed by the VOIP based telephony service 120.

The processor 150 shown in FIG. 2 may be one of any form of a general purpose computer processor used in accessing an IP-based network, such as a corporate intranet, the Internet or the like. The processor 150 comprises a central processing unit (CPU) 152, a memory 154, and support circuits 156 for the CPU 152. The processor 150 also includes provisions 158/160 for connecting the processor 150 to customer equipment and to service provider agent equipment, as well as possibly one or more input/output devices (not shown) for accessing the processor and/or performing ancillary or administrative functions related thereto. The provisions 158/160 are shown as separate bus structures in FIG. 2; however, they may alternately be a single bus structure without degrading or otherwise changing the intended operability of the processor 150.

The memory 154 is coupled to the CPU 152. The memory 154, or computer-readable medium, may be one or more of readily available memory such as random access memory (RAM), read only memory (ROM), floppy disk, hard disk, flash memory or any other form of digital storage, local or remote, and is preferably of non-volatile nature. The support circuits 156 are coupled to the CPU 152 for supporting the processor in a conventional manner. These circuits include cache, power supplies, clock circuits, input/output circuitry and subsystems, and the like.

A software routine 162, when executed by the CPU 152, causes the processor 150 to perform processes of the disclosed embodiments, and is generally stored in the memory 154. The software routine 162 may also be stored and/or executed by a second CPU (not shown) that is remotely located from the hardware being controlled by the CPU 152. Also, the software routines could also be stored remotely from the CPU. For example, the software could be resident on servers and memory devices that are located remotely from the CPU, but which are accessible to the CPU via a data network connection.

The software routine 162, when executed by the CPU 152, transforms the general purpose computer into a specific purpose computer that performs one or more functions of the IP telephony system 120. Although the processes of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routine 162 of the disclosed embodiments is capable of being executed on any computer operating system, and is capable of being performed using any CPU architecture.

In the following description, references will be made to an “IP telephony device.” This term is used to refer to any type of device which is capable of interacting with an IP telephony system to complete a telephone call. An IP telephony device could be an IP telephone, a computer running IP telephony software, a telephone adapter which is itself connected to a normal analog telephone, or some other type of device capable of communicating via data packets. An IP telephony device could also be a cellular telephone or a portable computing device that runs a software application that enables the device to act as an IP telephone. Thus, a single device might be capable of operating as both a cellular telephone and an IP telephone.

Moreover, certain devices that are not traditionally used as telephony devices may act as telephony devices once they are configured with appropriate application software. Thus, some devices that would not normally be considered telephony devices may become telephony devices or IP telephony devices once they are running appropriate software.

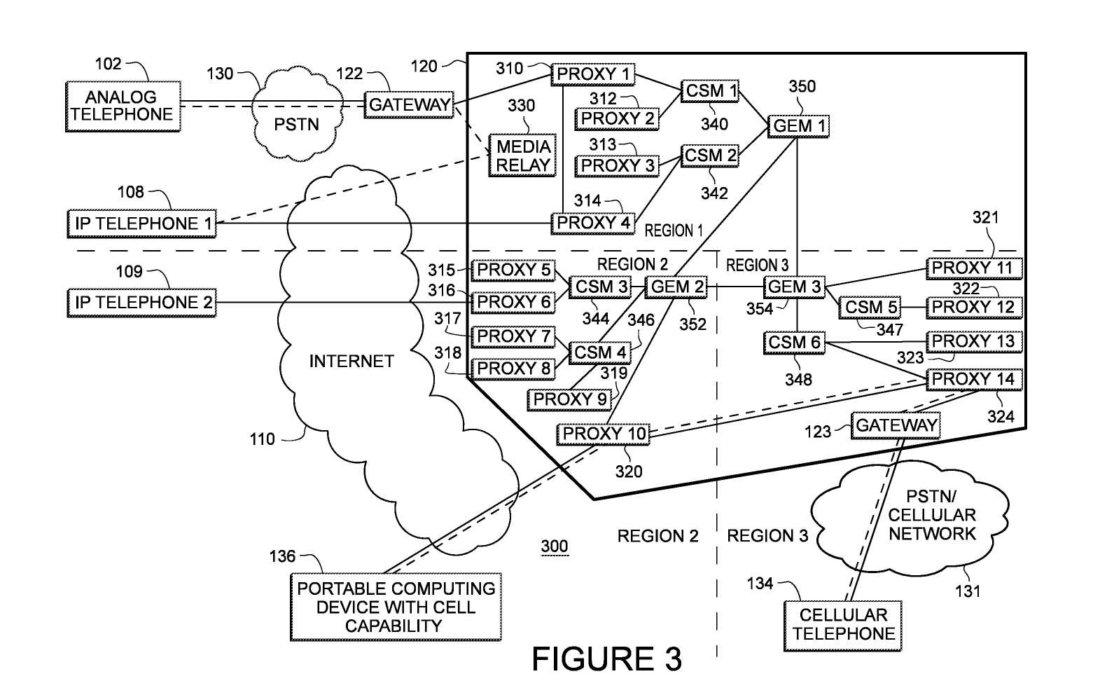

The following description explains how an IP telephony system can be configured to prevent multiple simultaneous calls from being conducted under the same user account on a worldwide basis. This explanation is provided in conjunction with the communication environment depicted in FIG. 3.

FIG. 3 illustrates a system architecture 300 in which the first IP telephone 108 and a second IP telephone 109 have access to an IP telephony system 120 via the Internet 110. In addition, a portable computing device with cell phone capabilities 136 is also able to access the IP telephony system 120 via the Internet 110. All three of these IP telephony devices are configured to send and receive telephone calls under the same user account.

FIG. 3 also illustrates an analog telephone 102 that is connected to a PSTN 130. The PSTN 130 is connected to a gateway 122 which allows the PSTN 130 to access the IP telephony system 120.

Likewise, a cellular telephone 134 is coupled to a PSTN/cellular network 131. The PSTN/cellular network 131 is capable of communicating directly with elements of the IP telephony system 120.

The elements depicted in FIG. 3 are located in three different geographical regions. The double dashed lines in FIG. 3 illustrate the boundaries between the first, second and third geographical regions (REGION 1, REGION 2 AND REGION 3 respectively). The analog telephone 102, the first IP telephone 108, and some portions of the IP telephony system 120 are located in the first geographical region. The second IP telephone 109, the portable computing device with cell phone capabilities 136 and some elements of the IP telephony system 120 are located in the second geographical region. The cellular telephone 134 and some elements of the IP telephony system 120 are located in the third geographical region.

The IP telephony system 120 includes multiple proxy servers which are used to communicate with elements outside the IP telephony system 120. First through fourth proxy servers 310, 312, 313, 314 are located in the first geographical region. Fifth through tenth proxy servers 315, 316, 317, 318, 319 and 320 are located in the second geographical region. Eleventh through fourteenth proxy servers 321, 322, 323, 324 are located in the third geographical region.

FIG. 3 illustrates a situation where the analog telephone 102 located within the first geographical region is used by a first calling party to place a call to the first IP telephone 108 which is also located within the first geographical region. The portable computing device with cell phone capability 136 that is located within the second geographical region is used by a second calling party to place a telephone call to a cellular telephone 134 located in the third geographical region.

When the first calling party dials the telephone number of the first IP telephone 108 on his analog telephone 102, call setup signaling is communicated to the PSTN 130, and then from the PSTN 130 to the IP telephony system 120 via the gateway 122. The call setup signaling is received by the first proxy server 310 of the IP telephony system 120. The first proxy server 310 consults with other elements of the IP telephony system 120 to determine how to setup the call to the first IP telephone 108. In this instance, the first proxy server 310 is instructed to reach the first IP telephone 108 via the fourth proxy server 314. The call setup signaling passes through the fourth proxy server 314 to the first IP telephone 108, and the call is established.

Part of the call setup signaling would inform both the first IP telephone 108 and the gateway 122 to route data packets bearing the media of the telephone call through a separate media relay 330 that is also located in the first geographical area. Once the call is underway, data packets bearing the audio of the call would pass back and forth between the first IP telephone 108 and the gateway 122 via the media relay 330. This would constitute a first call to an IP telephony device under the user account.

Next, the second caller places a call from the portable computing device with cell phone capability 136 to the cellular telephone 134. As noted above, the portable computing device with cell phone capability 136 is also configured under the same user account as the first IP telephone 108 and the second IP telephony device 109.

When the second caller dials the telephone number of the cellular telephone 134, call setup signaling is sent from the mobile computing device with cell phone capability 136 to the tenth proxy server 320 via the Internet 110. The tenth proxy server 320 consults with other assets of the IP telephony system 120 to determine how to route the call to the cellular telephone 134. The system would inform the tenth proxy server 320 to route the call through the fourteenth proxy server 324 located in the third geographical region.

The call setup signaling would pass to the fourteenth proxy server 324, then to a gateway 123, and then to a PSTN/cellular network 131 which would ultimately connect the call to the cellular telephone 134. In this instance, no media relay is used. As a result, the data packets bearing the media of the call pass along the same path as the data packets that contained the call setup signaling. This second call would be the second call setup to an IP telephony device that uses the same user account.

As explained, it is desirable for an IP telephony system to be able to manage and, if necessary, limit the total number of simultaneous calls that are associated with the same user account to prevent abuse of the system. The IP telephony system 120 includes first and second call state management units 340, 342 (CSM1 and CSM2 respectively) located in the first geographical region. The first call state management unit 340 is in communication with the first and second proxy servers 310, 312. The second call state management unit 342 is in communication with the third and fourth proxy servers 313, 314. In addition, all call state management units in the first geographical region are in communication with a first global event management unit 350 (GEM1).

The IP telephony system also includes a third call state management unit 344 (CSM3) in the second geographical region that is in communication with the fifth and sixth proxy servers 315, 316. A fourth call state management unit 346 (CSM4) in the second geographical area is in communication with the seventh, eighth and ninth proxy servers 317, 318, 319. All of the call state management units in the second geographical area are in communication with a second global event management unit 352 (GEM2). Also, FIG. 3 illustrates that the tenth proxy server 320 is in direct communication with the second global event management unit 352.

The IP telephony system also includes a fifth call state management unit 347 (CSM5) in the third geographical region that is in communication with the twelfth proxy server 322. A sixth call state management unit 348 (CSM6) in the third geographical region is in communication with the thirteenth and fourteenth proxy servers 323, 324. FIG. 3 also illustrates that the eleventh proxy server is in direct communication with a third global event management unit 354 (GEM3).

The first, second and third global event management units 350, 353, 354 each maintain a copy of a call session database (not shown). The call session database has entries for the telephone calls that are currently being handled by the IP telephony system 120. This includes calls in the setup state, and calls that are connected and ongoing. The object is for all of the global event management units to have a copy of the call session database that is as current as possible. To keep each copy of the call session database current, the global event management units are constantly sharing information.

When a new call setup request is received by a proxy server in a geographical region, the proxy server sends a message to either a call state management unit or directly to a global event management unit located within its geographical area. If the proxy server sends that message to a call state management unit, the call state management unit forwards the message on to the appropriate global event management unit.

The messages sent from the proxy server to either a call state management unit or a global event management unit include an indication of the user account associated with the IP telephony device to which or from which the call is being routed. This information is added to the call session database being maintained by the global event management units.

For example, when the first caller used the analog telephone 102 to call the first IP telephone 108, call setup signaling was first received by the first proxy server 310. When that call setup signaling was received, the first proxy server sends a message to the first call state management unit 340 indicating that a call is being setup to the first IP telephone 108. This message is relayed from the first call state management unit 340 to the first global event management unit 350. The first global event management unit then adds an entry to its call session database to indicate that a call is being setup to the first IP telephone 108, which is associated with a particular user account.

The first global event management unit 350 then shares this information with the second and third global event management units 352, 354 so that the call session databases being maintained by the second and third global event management units 352, 354 are up-to-date. This could occur as soon as the first global event management unit 350 learns of the information. Alternatively, the global event management units could share information between themselves on a periodic basis. One of the aims, however, is for the call session databases maintained by the different global event management units to be as up-to-date as possible. Thus, if the sharing of information is conducted on a periodic basis, the sharing will occur very frequently.

Another aspect to the system is that the proxy servers check with the call state management unit or the global event management unit with which they communicate each time that a new call setup request is received. The idea is for the proxy server to determine whether the maximum number of simultaneous calls for a particular user account are already being carried by the IP telephony system 120. If not, the proxy server will go ahead and attempt to setup the requested call. If so, the proxy server will refuse the call setup request.

For example, when the portable computing device with cell phone capability 136 tries to establish a call with the cellular telephone 134, the call setup request is first received by the tenth proxy server 320. The tenth proxy server sends a message to the second global event management unit 352 asking whether it is acceptable to setup the requested call. The second global event management unit 352 consults its copy of the call session database. It would determine that there is presently only one other call being carried by the IP telephony system for that user account—the one ongoing between the analog telephone 102 and the first IP telephone 108.

If it is acceptable under the terms of that user account to have two simultaneous calls, the second global event management unit 352 sends an OK signal to the tenth proxy server 320. The second global event management unit 352 also updates its copy of the call session database to indicate that a second call under the user account is underway. And this information is transmitted to the first and third global event management units 350, 354 so that they can also update their copies of the call session database.

When the tenth proxy server 320 receives the OK from the second global event management unit 352, it proceeds with the call setup to the cellular telephone 134, as explained above.

Each time that a proxy server is successful in setting up a telephone call, the proxy server sends an additional message to the call state management unit or global event management unit with which it communicates to indicate that call setup is complete and that the call is ongoing. When such a message is sent, the global event management unit updates its copy of the call session database with this information, and the information is also sent to the other global event management units within the system.

If call setup fails, or if a call is terminated by one of the parties to the call, the proxy server that setup the call will send a message to the call state management unit or global event management unit with which it communicates to indicate that call has terminated. When such a message is sent, the global event management unit updates its copy of the call session database with this information, and the information is also sent to the other global event management units within the system.

Because a check is performed before each call is setup to determine if the user account has already reached its maximum number of simultaneous calls, the system can prevent a user from abusing the system. For example, the second IP telephone 109 illustrated in FIG. 2 is associated with the same user account as the first IP telephone 108 and the portable computing device with call phone capability 136. If a third caller attempts to place a call using the second IP telephone 109, the call setup request is received by the sixth proxy server 316. The sixth proxy server 316 communicates with the third call state management unit 344 to determine if it is acceptable to connect the call. This request is relayed to the second global event management unit 352 by the third call state management unit 344.

The second global event management unit 352 consults its copy of the call session database and it determines that there are already two ongoing calls associated with the user account. The first call between the analog telephone 102 and the first IP telephone 108, and the second call between the portable computing device with call phone capability 136 and the cellular telephone 134. Because this user account can only have a maximum of two simultaneous calls, the second global event management unit 352 sends a deny message back to the sixth proxy server 316 via the third call state management unit 344.

By arranging the IP telephony system 120 as described above, where only a limited number of global event management units are responsible for keeping a call session database up-to-date, it is possible to rapidly exchange information between the global event management units. This ensures that the call session databases are rapidly synchronized. As a result, it is difficult or impossible for a user to abuse the system, even when multiple call setup requests associated with the same user account are coming from vastly different geographical locations.

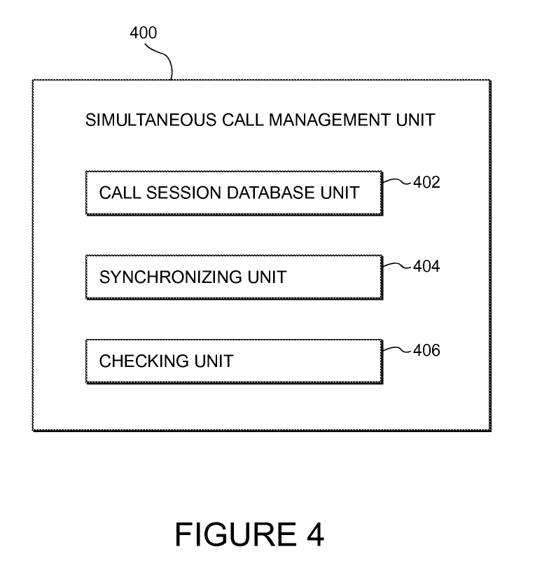

FIG. 4 illustrates a simultaneous call management unit 400 that coordinates the activities of various elements of an IP telephony system to accomplish the functions explained above. The simultaneous call management unit 400 includes a call session database unit 402 that maintains a plurality of regional call session databases. As explained above, each regional call session database includes entries corresponding to each of the ongoing telephone calls placed through the IP telephony system to a telephony device within that region. A synchronizing unit 404 synchronizes all of the regional call session databases on a periodic basis. A checking unit 406 is responsible for checking the local regional call session database when a new call setup request is received to determine the number, if any, of existing calls that are ongoing under the same user account that is associated with the new call setup request.

Although the foregoing description illustrated a single global event management unit in each of the three geographical regions, in alternate embodiments, more than one global event management unit may be present in each geographical region. When multiple global event management units are present in a single geographical region, a first global event management unit may be in communication with a first group of call state management units, and a second global event management unit may be in communication with a second group of call state management units. Alternatively, both global event management units may be in communication with all call state management units. This would allow one of the global event management units to act as a primary, and the second global event management unit to act as a backup.

Also, as explained above, proxy servers may communicate with a global event management unit directly, or via an intervening call state management unit.

In the foregoing description, the IP telephony system 120 acted to prevent more than two simultaneous calls on the same user account. In some instances, only one call may be permitted to proceed under a user account at any given time. Also, in some circumstances, more than two simultaneous calls may be permitted under a single user account.

Moreover, the IP telephony system may make a distinction about what type of simultaneous calls can be conducted under a single user account. For example, the IP telephony system may allow only one call from an IP telephony device associated with the user's residence, but allow three simultaneous calls to proceed if all three are from mobile telephony devices registered under a mobile extension plan. The terms of each service plan with the user would control.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of managing the number of simultaneous telephone calls that can be placed through an Internet protocol (IP) telephony system under a single user account, comprising:
creating a plurality of regional call session databases, wherein each regional call session database includes entries corresponding to each of the ongoing telephone calls placed through the IP telephony system to a telephony device within that region, and wherein each entry includes an indication of a user account associated with the call;
synchronizing all of the regional call session databases on a periodic basis;
checking the local regional call session database when a new call setup request is received to determine the number, if any, of existing calls that are ongoing under the same user account that is associated with the new call setup request; and
managing the setup of a new call based on the number of existing calls that are ongoing under the same user account that is associated with the new call setup request.

2. The method of claim 1, further comprising:
adding a call session entry to a regional call session database each time that a new call is initiated to or from a telephony device located within the region by the IP telephony system; and
deleting a call session entry from a regional call session database when the call associated with the call session entry is terminated;

3. The method of claim 2, wherein the synchronizing step comprises:
causing new call session entries added to each regional database to be added to all other regional databases; and
causing call session entries deleted from each regional call session database to be deleted from all other regional call session databases.

4. The method of claim 2, wherein the adding step comprises:
receiving a call setup request at a proxy server of the IP telephony system; and
sending a notification from the proxy server to a regional global event management unit that a call is being setup to or from a telephony device within the region.

5. The method of claim 4, wherein sending the notification comprises sending an indication of a user account associated with the telephony device.

6. The method of claim 2, wherein the adding step comprises:
receiving a call setup request at a proxy server of the IP telephony system;
sending a notification from the proxy server to a regional call state management unit that a call is being setup to or from a telephony device within the region; and
sending a notification from the regional call state management unit to a regional global event management unit that a call is being setup to or from a telephony device within the region.

7. The method of claim 6, wherein sending a notification from the regional call state management unit to the regional global event management unit comprises sending an indication of a user account associated with the telephony device.

8. The method of claim 1 wherein the step of managing further comprises blocking the setup of a new call if completing the new call would result in the number of simultaneous calls placed under a single user account exceeding an upper limit.

9. A system for managing the number of simultaneous telephone calls that can be placed through an Internet protocol (IP) telephony system under a single user account, comprising:
means for creating a plurality of regional call session databases, wherein each regional call session database includes entries corresponding to each of the ongoing telephone calls placed through the IP telephony system to a telephony device within that region, and wherein each entry includes an indication of a user account associated with the call;
means for synchronizing all of the regional call session databases on a periodic basis;
means for checking the local regional call session database when a new call setup request is received to determine the number, if any, of existing calls that are ongoing under the same user account that is associated with the new call setup request; and
means for managing the setup of the new call based on the number of existing, ongoing calls under the same user account.

10. A system for managing the number of simultaneous telephone calls that can be placed through an Internet protocol (IP) telephony system under a single user account, comprising:
a call session database unit that maintains a plurality of regional call session databases, wherein each regional call session database includes entries corresponding to each of the ongoing telephone calls placed through the IP telephony system to a telephony device within that region, and wherein each entry includes an indication of a user account associated with the call;
a synchronizing unit that synchronizes all of the regional call session databases on a periodic basis;
a checking unit that checks the local regional call session database when a new call setup request is received to determine the number, if any, of existing calls that are ongoing under the same user account that is associated with the new call setup request; and
a managing unit that manages the setup of a new call based on the number of existing calls that are ongoing under the same user account associated with the new call setup request.

11. The system of claim 10, wherein the call session database unit causes a call session entry to be added to a regional call session database each time that a new call is initiated to or from a telephony device located within the region by the IP telephony system, and wherein the call session database unit causes a call session entry to be deleted from a regional call session database when the call associated with the call session entry is terminated;

12. The system of claim 11, wherein the synchronizing unit causes new call session entries added to each regional database to be added to all other regional databases, and wherein the synchronizing unit also causes call session entries deleted from each regional call session database to be deleted from all other regional call session databases.

13. The system of claim 11, further comprising a plurality of global event management units, wherein each global event management unit serves a different geographical region, and wherein when the call session database unit causes a call session entry to be added to a regional call session database, the call session database unit causes a notification to be sent to the applicable regional global event management unit indicating that a call is being setup to or from a telephony device within the region.

14. The system of claim 13, wherein the notification includes an indication of a user account associated with the telephony device.

15. The system of claim 11, further comprising a plurality of call state management units, wherein each call state management unit serves a particular geographical region, and wherein at least some regions are served by a plurality of call state management units, and wherein when the call session database unit causes a call session entry to be added to a regional call session database, the call session database unit causes a notification to be sent to an applicable regional call state management unit indicating that a call is being setup to or from a telephony device within the region.

16. The system of claim 15, further comprising a plurality of global event management units, wherein each global event management unit serves a different geographical region, and wherein each time that a call state management unit receives a notification that a call is being setup to or from a telephony device with the region, the call state management unit causes a notification to be sent to the applicable regional global event management unit indicating that the call is being setup.

17. The system of claim 16, wherein the notification sent from the regional call state management unit to the regional global event management unit comprises an indication of a user account associated with the telephony device.

18. The system of claim 1, wherein the managing unit blocks the setup of a new call if completing the new call would result in the number of simultaneous calls placed under a single user account exceeding an upper limit.

19. A method of synchronizing a plurality of regional call session databases that are maintained by an IP telephony system, wherein each regional call session database includes entries corresponding to each of the ongoing telephone calls placed through the IP telephony system to a telephony device within that region, and wherein each entry includes an indication of a user account associated with the call, the method comprising:
causing new entries added to a regional database to be added to all other regional databases; and
causing entries deleted from a regional call session database to be deleted from all other regional call session databases.

20. The method of claim 19, wherein the step of causing new entries added to a regional database to be added to all other regional databases is performed immediately after each new entry is made, and wherein the step of causing entries deleted from a regional call session database to be deleted from all other regional call session databases is performed immediately after the entry is deleted.

21. The method of claim 19, wherein the step of causing new entries added to a regional database to be added to all other regional databases, and the step of causing entries deleted from a regional call session database to be deleted from all other regional call session databases are performed on a periodic basis.
